(19) United States
(12) Patent Application Publication
(10) Pub. No.: US 2012/0321116 A1
(43) Pub. Date: Dec. 20, 2012

(54) SPEAKER ASSEMBLY WITH AIR RETARDING HOUSING

(75) Inventor: HWANG-MIAW CHEN, Tu-Cheng (TW)

(73) Assignee: HON HAI PRECISION INDUSTRY CO., LTD., Tu-Cheng (TW)

(21) Appl. No.: 13/598,644

(22) Filed: Aug. 30, 2012

Related U.S. Application Data
(63) Continuation-in-part of application No. 13/207,428, filed on Aug. 11, 2011.

(30) Foreign Application Priority Data
Jun. 17, 2011 (CN) 201110163948.5

(51) Int. Cl. H04R 1/02

(52) U.S. Cl. 381/332

(57) ABSTRACT

An exemplary speaker assembly includes an enclosure, a loudspeaker, a sound-guiding channel, and a housing. The enclosure has a receiving chamber and an acoustic chamber. The loudspeaker is accommodated in the receiving chamber. The sound-guiding channel is formed in the acoustic chamber. The sound-guiding channel has a first end with a first opening and a second end with a second opening. The second opening communicates the sound-guiding channel with the surrounding environment. The housing is received in the sound-guiding channel. The housing includes a passage communicating the first opening with the sound-guiding channel. The passage is narrow at a first position of the housing and wide at a second position of the housing.

### CROSS-REFERENCE TO RELATED APPLICATION

The present application is a continuation-in-part (CIP) application of patent application Ser. No. 13/207,428, entitled “SPEAKER ASSEMBLY WITH AIR RETARDING CUSHION,” and filed on Aug. 11, 2011. The disclosure of the parent application is incorporated herein by reference in its entirety.

### BACKGROUND

1. Technical Field

The disclosure generally relates to speaker assemblies, and more particularly to a speaker assembly having a sound-guiding channel.

2. Description of Related Art

In some applications, a speaker assembly is provided with a sound-guiding channel. Sound generated at a rear side of a loudspeaker transmits to the surrounding environment through the sound-guiding channel and then resonates with sound generated at a front side of the loudspeaker. Therefore, the sound quality of the speaker assembly at low frequencies is improved. However, when air enters the sound-guiding channel, the speed of moving air inside the sound-guiding channel increases, and friction between the air and the walls of the sound-guiding channel generates noise.

What is needed, therefore, is a speaker assembly to overcome the described limitations.

### BRIEF DESCRIPTION OF THE DRAWINGS

FIG. 1 is an isometric view of a speaker assembly in accordance with a first embodiment of the present disclosure.

FIG. 2 is an exploded view of the speaker assembly of FIG. 1.

FIG. 3 is an isometric view of an upper shell of the speaker assembly of FIG. 2, but showing the upper shell inverted.

FIG. 4 is an assembled view of a lower shell and a covering plate of the speaker assembly of FIG. 2.

FIG. 5 is an isometric view of a lower shell of the speaker assembly of FIG. 2, but showing the lower shell inverted.

FIG. 6 is a cross-sectional view of an air retarding housing of the speaker assembly of FIG. 2.

FIG. 7 is a cross-sectional view of an air retarding housing of a speaker assembly in accordance with a second embodiment of the present disclosure.

FIG. 8 is a cross-sectional view of an air retarding housing of a speaker assembly in accordance with a third embodiment of the present disclosure.

### DETAILED DESCRIPTION

A speaker assembly in accordance with a first embodiment of the present disclosure will now be described in detail below and with reference to the drawings.

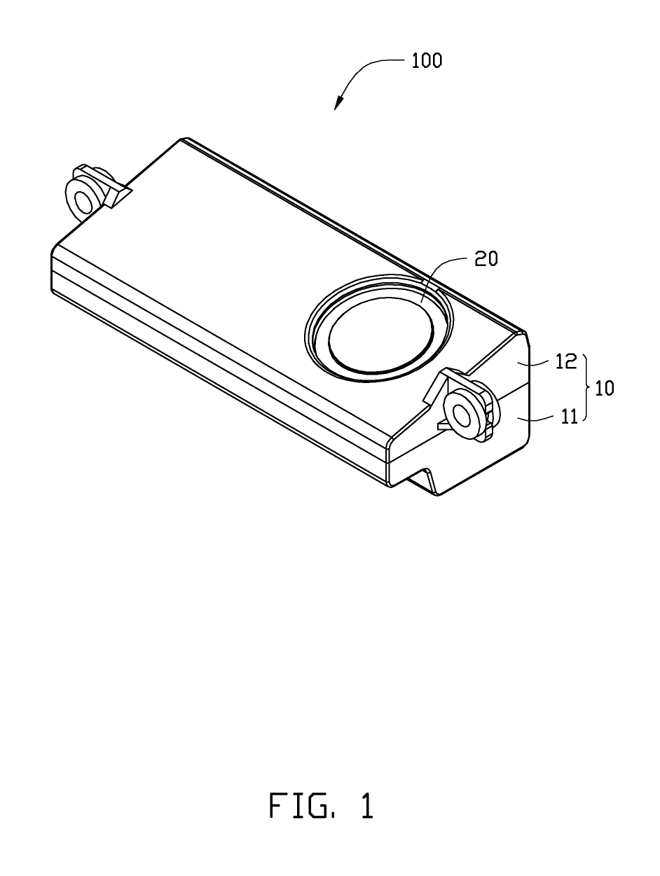

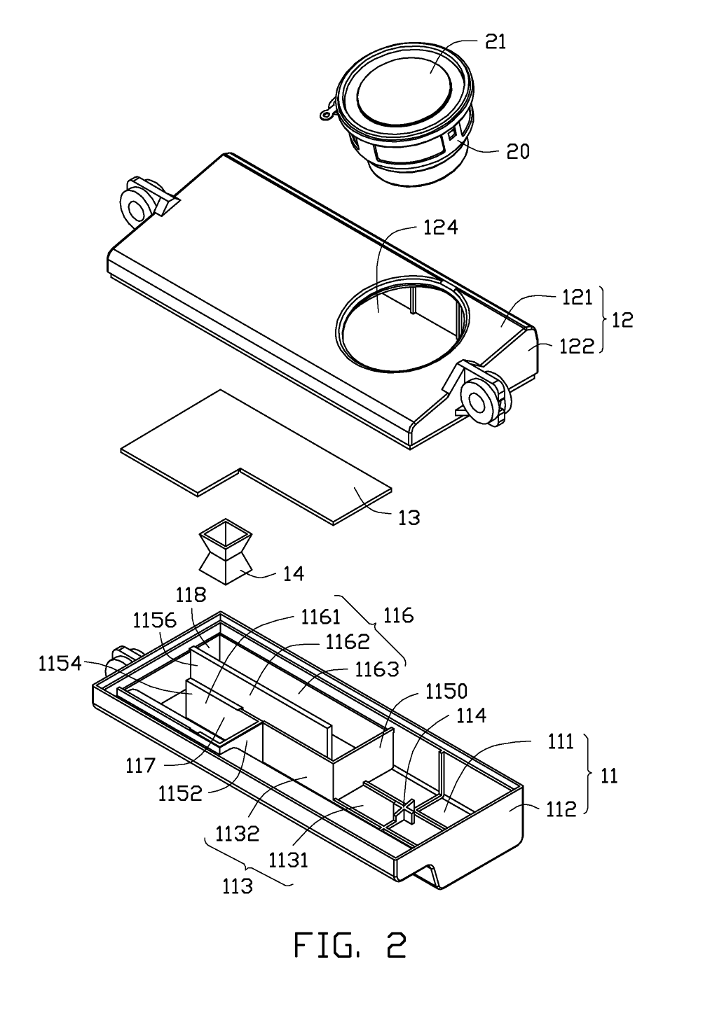

Referring to FIGS. 1-2, the speaker assembly 100 includes an enclosure 10, and a loudspeaker 20 secured in the enclosure 10.

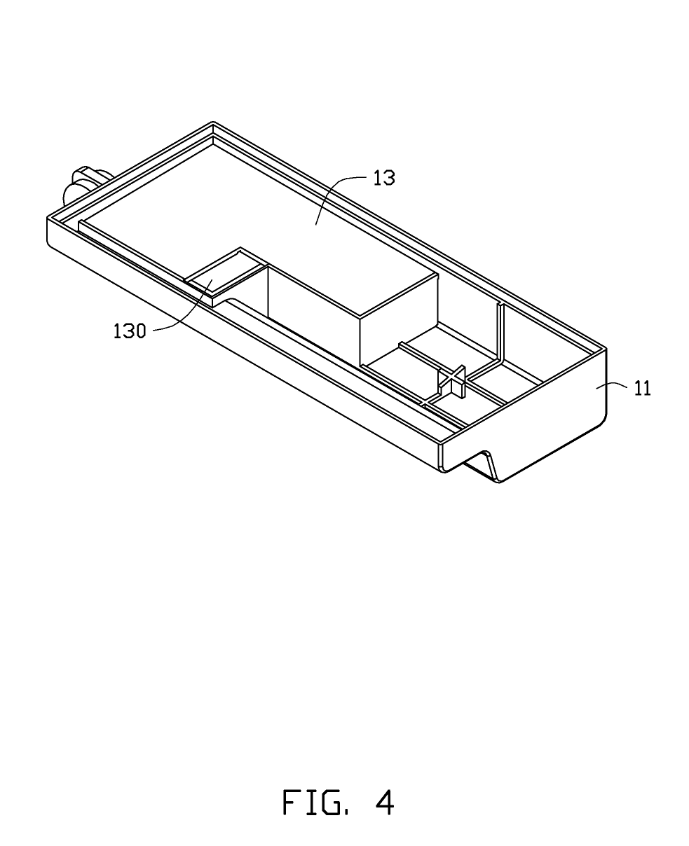

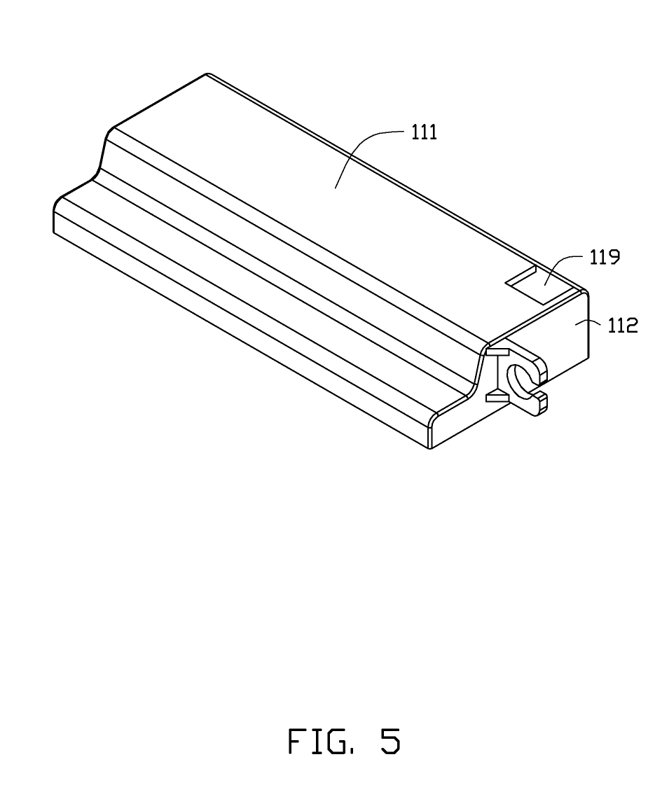

The enclosure 10 includes a lower shell 11, and an upper shell 12 connected with the lower shell 11. Referring also to FIGS. 4-5, the lower shell 11 includes a bottom wall 111, and a side wall 112 extending upwardly from the bottom wall 111. The bottom wall 111 and the side wall 112 cooperatively define a first chamber 113. The first chamber 113 includes a first receiving chamber 1131 for accommodating the loudspeaker 20, and a first acoustic chamber 1132 communicating with the first receiving chamber 1131. A cross-shaped supporting member 114 is formed on a top face of the bottom wall 111 for supporting the loudspeaker 20. A plurality of spacing plates 1150, 1152, 1154, 1156 are formed in the first acoustic chamber 1132, and connect with the bottom wall 111 and the side wall 112. The spacing plates 1150, 1152, 1154, 1156 includes a first spacing plate 1150 connected to the side wall 112, a second spacing plate 1152 parallel to the first spacing plate 1150 and connected to the side wall 112, a third spacing plate 1154 perpendicular to the first spacing plate 1150 and interconnecting the first spacing plate 1150 and the second spacing plate 1152, and a fourth spacing plate 1156 parallel to the third spacing plate 1154 and connected to the side wall 112. A covering plate 13 is formed on an upper side of the spacing plates 1150, 1152, 1154, 1156.

The spacing plates 1150, 1152, 1154, 1156, the bottom wall 111 and side wall 112 of the lower shell 11, together with the covering plate 13, cooperatively define a sound-guiding channel 116. The sound-guiding channel 116 has a first end 117 adjacent to the second spacing plate 1152 and a second end 118 adjacent to the fourth spacing plate 1156. The covering plate 13, the side wall 112, the second spacing plate 1152 and the third spacing plate 1154 cooperatively define a first opening 130 (see FIG. 4) at the first end 117 of the sound-guiding channel 116. The first opening 130 communicates the first end 117 of the sound-guiding channel 116 with the first acoustic chamber 1132. A second opening 119 (see FIG. 5) is defined in the bottom wall 111 of the lower shell 11 at the second end 118. The second opening 119 communicates the second end 118 of the sound-guiding channel 116 with a surrounding environment. The first opening 130 and the second opening 119 both are rectangular.

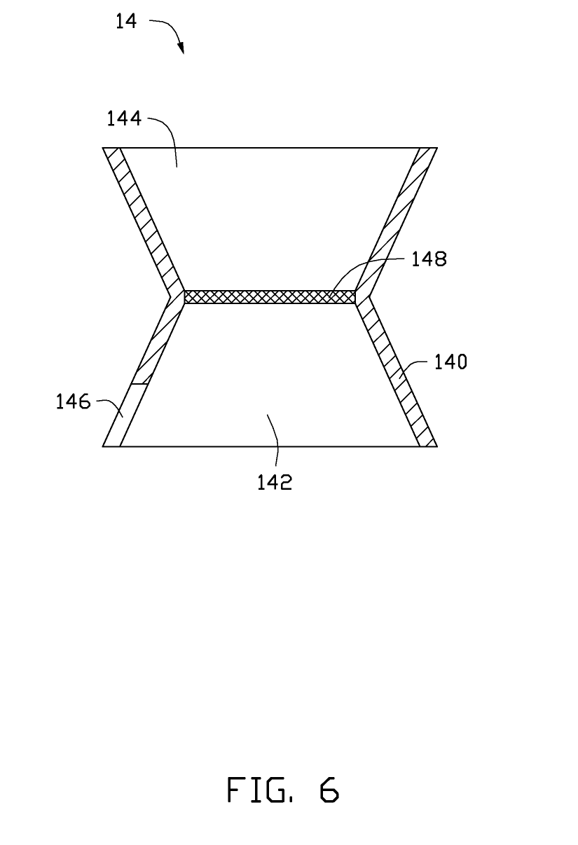

In this embodiment, the sound-guiding channel 116 includes a first section 1161, a second section 1162 and a third section 1163 all parallel to each other. The second section 1162 is between the first section 1161 and the third section 1163. Two ends of the second section 1162 communicate with the first section 1161 and the third section 1163. In addition, a length of the first section 1161 is less than a length of the second section 1162 and the third section 1163. A housing 14 is disposed in the first section 1161 of the sound-guiding channel 116 at the first opening 130. The housing 14 has a shape similar to a funnel. Referring also to FIG. 6, the housing 14 includes four side plates 140 connected to each other. The four side plates 140 cooperatively enclose a passage 142 within the housing 14. A diameter of the passage 142 is firstly decreased and then increased along a top-to-bottom or bottom-to-top direction of the housing 14. The passage 142 is narrow at a middle of the housing 14 along a height of the housing 14, and wide at a top and a bottom of the housing 14. An entrance 144 is formed at a top of the passage 142. An exit 146 is defined in a bottom of a corresponding side plate 140. The exit 146 is smaller than the entrance 144 and the narrow portion of the passage 142 at the middle of the housing 14.

The housing 14 is disposed in the sound-guiding channel 116 in a manner that bottoms of the side plates 140 contact a top face of the bottom wall 111 of the lower shell 11, the entrance 144 is located below and faces the first opening 130, and the exit 146 faces the first section 1161 of the sound-guiding channel 116 in a direction away from the second spacing plate 1152. Thus, the entrance 144 communicates the opening 130 with the passage 142 along a vertical direction, and the exit 146 communicates the passage 142 with the first section 1161 of the sound-guiding channel 116 along a horizontal direction. When the air oscillated by the loudspeaker 20 enters the passage 142 from the entrance 144, the air will be slowed by the passage 142 shrinking at the middle of the housing 14 along the height of the housing 14 and the exit 146 twice, and then flow into the sound-guiding channel 116 through the exit 146 in a low speed. Accordingly, the air flowing through the sound-guiding channel 116 will not produce a large noise in such a low speed. Furthermore, a cushion 148 may be disposed in the passage 142 at the middle of the housing 14 along the height of the housing 14. The cushion 148 may be made of porous materials such as wire netting, a nylon netting, or an adhesive-bonded fabric. The cushion 148 can further reduce the air speed passing through the passage 142 of the housing 14.

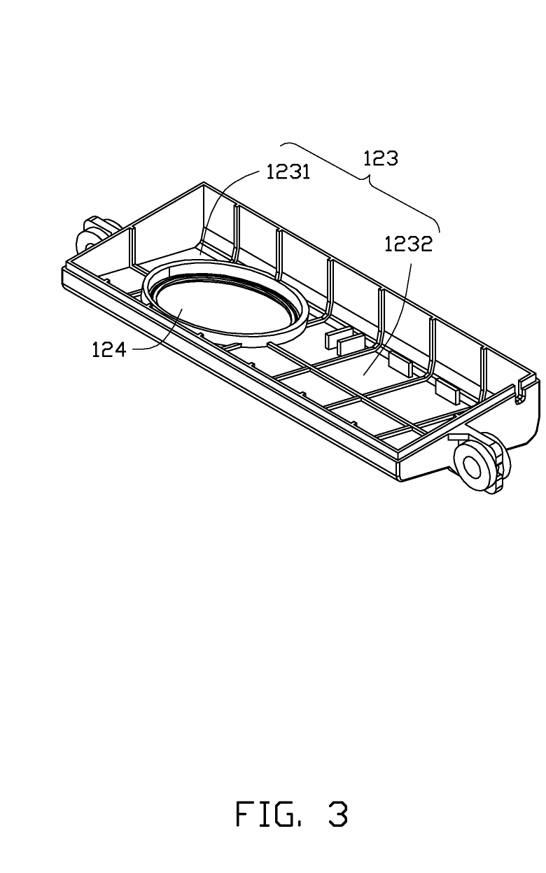

Referring to FIGS. 2-3, the upper shell 12 includes an upper wall 121, and a side wall 122 extending downwardly from the upper wall 121. The upper wall 121 and the side wall 122 cooperatively form an upper chamber 123. The upper chamber 123 includes a second receiving chamber 1231 for receiving the loudspeaker 20, and a second acoustic chamber 1232 communicating with the second receiving chamber 1231. The second receiving chamber 1231 and the second acoustic chamber 1232 correspond to the first receiving chamber 1131 and the first acoustic chamber 1132, respectively. A through hole 124 is defined in the upper wall 121 for exposing the second receiving chamber 1231.

In assembling of the speaker assembly 100, the lower shell 11 and the upper shell 12 are connected together to form the enclosure 10. The first receiving chamber 1131 and the second receiving chamber 1231 cooperatively form a receiving chamber (not labeled) for accommodating the loudspeaker 20. The first acoustic chamber 1132 and the second acoustic chamber 1232 cooperatively form an acoustic chamber (not labeled) of the enclosure 10. The acoustic chamber is positioned at one side of the loudspeaker 20, and sound generated at a bottom of the loudspeaker 20 resonates in the acoustic chamber. The loudspeaker 20 corresponds to the through hole 124. The loudspeaker 20 has a diaphragm 21 at a top end thereof, and a bottom end supported by the supporting member 114. The top end of the loudspeaker 20 is secured to the upper wall 121 of the upper shell 12 such that the diaphragm 21 is exposed to the surrounding environment via the through hole 124.

In operation, the diaphragm 21 vibrates, and sounds are generated from the a top and the bottom of the loudspeaker 20. Sound generated at the top of the loudspeaker 20 transmits to the surrounding environment via the through hole 124. Sound generated at the bottom of the loudspeaker 20 transmits to the sound-guiding channel 116 through the first opening 130, and then to the surrounding environment through the second opening 119. Therefore, sound coming from the through hole 124 resonates with sound coming from the second opening 119, and the sound properties of the speaker assembly 100 at low frequencies are improved.

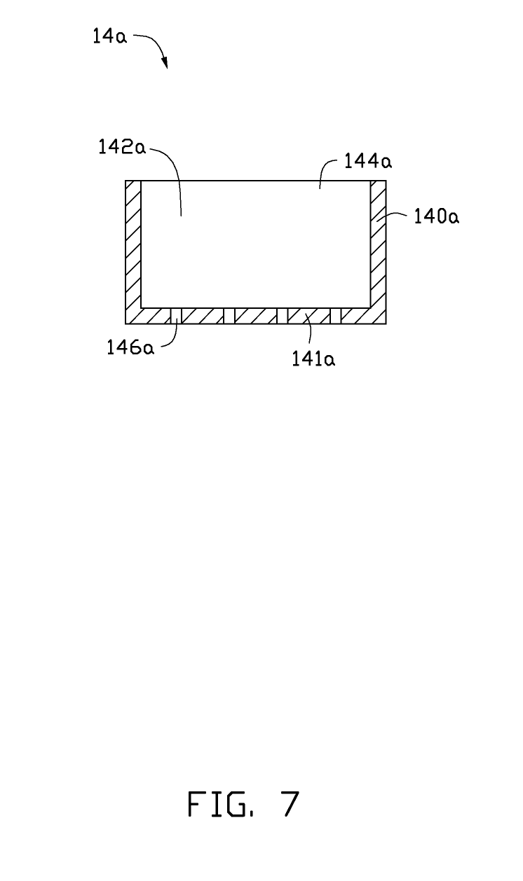

Alternatively, the housing 14 may have other configurations besides the funnel described above. Referring to FIG. 7, a rectangular housing 14a is shown. The rectangular housing 14a also includes four side plates 140a connected to each other and surrounding a passage 142a therebetween. An entrance 144a is formed at a top of the passage 142a. The housing 14a has a bottom plate 141 a connecting the four side plates 140a to cover a bottom of passage 142a. A plurality of exits 146a are defined in the bottom plate 141a to communicate the passage 142a with a space below the housing 14a. Different from the funnel-shaped housing 14 of the previous embodiment, the rectangular housing 14a is attached to the covering plate 13 by adhering top ends of the side plates 140a to a bottom face of the covering plate 13. Thus, the exits 146a are located above and spaced from the bottom wall 111 of the lower shell 11, and therefore communicate the passage 142a with the first section 1161 of the sound-guiding channel 116 along a vertical direction. The variation of the diameter of the passage 142a from the entrance 144a to the exits 146a can also reduce the air speed passing through the housing 14a.

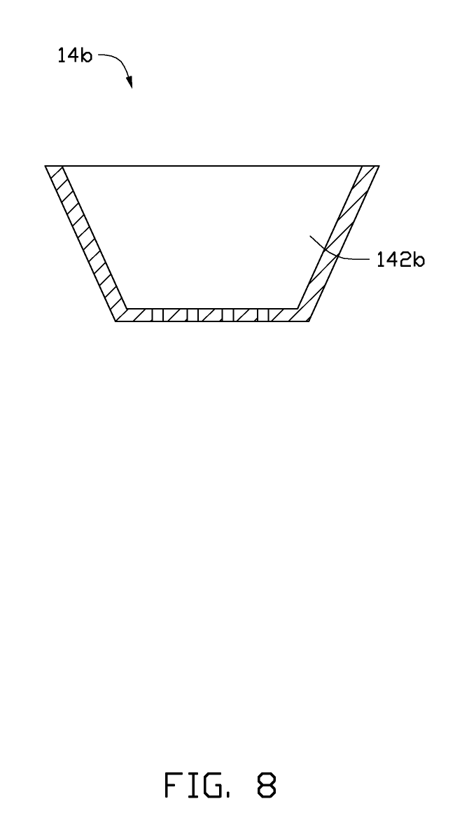

In addition, the housing may be further varied to have a blow-like shape as shown in FIG. 8. In this embodiment, a diameter of a passage 142b of a housing 14b is gradually decreased from a top-to-bottom direction of the housing 14b.

It is to be understood, however, that even though numerous characteristics and advantages of the present embodiments have been set forth in the foregoing description, together with details of the structures and functions of the embodiments, the disclosure is illustrative only, and changes may be made in detail, especially in matters of shape, size, and arrangement of parts within the principles of the disclosure to the full extent indicated by the broad general meaning of the terms in which the appended claims are expressed.

What is claimed is:

1. A speaker assembly, comprising:
an enclosure defining a receiving chamber and an acoustic chamber communicating with the receiving chamber;
a loudspeaker accommodated in the receiving chamber in a position adjacent to the acoustic chamber;
a sound-guiding channel formed in the acoustic chamber, the sound-guiding channel comprising a first end defining a first opening and a second end defining a second opening, the first opening communicating with the acoustic chamber, the second opening communicating the sound-guiding channel with a surrounding environment of the speaker assembly; and
a housing defining a passage communicating the first opening with the sound-guiding channel, the passage being narrow at a first position thereof and wide at a second position thereof, and air flowing through the passage being slowed at the first position of the passage.

2. The speaker assembly of claim 1, wherein the passage has an entrance communicating with the first opening, and an exit communicating with the sound-guiding channel.

3. The speaker assembly of claim 2, wherein the entrance is located higher than the exit.

4. The speaker assembly of claim 2, wherein the entrance is larger than the exit.

5. The speaker assembly of claim 2, wherein the housing comprises a plurality of side plates connected to each other, the passage being enclosed by the side plates.

6. The speaker assembly of claim 5, wherein the exit is defined in one side plate of the housing and adjacent to a bottom of the housing, and the entrance is defined in a top of the housing.

7. The speaker assembly of claim 6, wherein the passage is narrow at a middle of the housing along a height direction of the housing, and is wide at the top of the housing.

8. The speaker assembly of claim 7, wherein the housing has a cushion received in the passage at the middle of the housing along the height direction of the housing.

9. The speaker assembly of claim 8, wherein the cushion is made of a porous material.

10. The speaker assembly of claim 5, wherein the housing further comprises a bottom plate connecting the side plates, the exit being defined in the bottom plate.

11. The speaker assembly of claim 10, wherein a diameter of the passage is decreased along a top-to-bottom direction of the housing.

12. The speaker assembly of claim 11, wherein the housing has a rectangular shape.

13. The speaker assembly of claim 11, wherein the housing has a blow-like shape.

14. The speaker assembly of claim 1, wherein the housing has a shape of funnel.

15. The speaker assembly of claim 14, wherein a diameter of the passage is firstly increased and then decreased along a top-to-bottom direction of the housing.

16. The speaker assembly of claim 1, wherein the enclosure comprises an upper shell and a lower shell connected to the upper shell, the loudspeaker being fixed in the upper shell, and the second opening being defined in the lower shell.

17. The speaker assembly of claim 16, wherein the lower shell comprises a bottom wall, a side wall extending upwardly from a periphery of the bottom wall, and a plurality of spacing plates formed on the bottom wall, the spacing plates defining the sound-guiding channel therebetween.

18. The speaker assembly of claim 17, wherein the enclosure further comprises a covering plate disposed on the spacing plates, the covering plate and the spacing plates cooperatively defining the first opening.

19. The speaker assembly of claim 17, wherein the lower shell comprises a cross-shaped supporting member formed on the bottom wall to support the loudspeaker.

20. The speaker assembly of claim 1, wherein the housing is received in the sound-guiding channel.
